(19) United States
(12) Patent Application Publication
(10) Pub. No.: US 2012/0097486 A1
(43) Pub. Date: Apr. 26, 2012

(54) ELEVATOR SYSTEM

(75) Inventors: Naohiko Suzuki, Tokyo (JP); Masahito Fukuta, Aichi (JP)

(73) Assignee: MITSUBISHI ELECTRIC CORPORATION, TOKYO (JP)

(21) Appl. No.: 13/381,120

(22) PCT Filed: Oct. 19, 2009
(86) PCT No.: PCT/JP2009/067998

§ 371 Date: Dec. 28, 2011

(51) Int. Cl. B66B 1/18

(52) U.S. Cl. 187/384

(57) ABSTRACT

In an elevator system, a security gate includes a gate box body, an opening/closing member, an input section for inputting identification information of a user, a display section, and a gate control section connected to an elevator group supervisory device. The gate control section controls opening/closing of the opening/closing member in accordance with the identification information input to the input section and controls the display section to display elevator information of elevators. The display section is provided on a side surface of the gate box body on a passage side and includes a display screen provided so as to be inclined with respect to a direction of passage of the user so as to be oriented to an entrance side of the security gate.

### TECHNICAL FIELD

The present invention relates to an elevator system in which personal authentication at a security gate and elevator control by an elevator group supervisory device are associated with each other.

### BACKGROUND ART

In a conventional automatic ticket gate, a display screen is provided on an upper surface of a box body so as to be in parallel or approximately in parallel to a floor surface (for example, see Patent Literature 1).

### CITATION LIST

### Patent Literature

Patent Literature 1: JP 2004-70549 A

### SUMMARY OF INVENTION

### Technical Problem

In recent years, there has been proposed an elevator system which assigns elevators based on the result of personal authentication performed at a security gate. When the conventional automatic ticket gate described above is used for the security gate of the elevator system described above, there is a high possibility that a user directly passes through the security gate after visually confirming the opening of an opening/closing member to result in an oversight of the display screen. If the display screen is overlooked as described above, the assigned elevator cannot be identified even though the personal authentication and the assignment of the elevators are associated with each other. Moreover, when the user who has overlooked the display screen is going to use an elevator different from the assigned one, there is a possibility of lowered travel efficiency of the overall elevator system. Further, when the display screen is provided on the upper surface of the box body in the case where a height of the box body of the security gate is relatively large, the display screen is hard to see. As a result, the possibility of overlooking the display screen becomes further higher. In addition, there is a possibility that the user stops to prevent a smooth passage.

The present invention has been made to solve the problems described above, and has an object to provide an elevator system capable of reducing the possibility of overlooking elevator information to allow a plurality of elevators to efficiently travel.

### Solution to Problems

An elevator system according to the present invention includes: a plurality of elevators available at a common elevator landing; an elevator group supervisory device for controlling travel of the plurality of elevators; and a security gate including: a gate box body arranged vertically on a side of a passage to the common elevator landing; an opening/closing member provided to the gate box body, for opening/closing the passage; an input section provided to the gate box body, for inputting identification information of a user; a display section provided to the gate box body; and a gate control section connected to the elevator group supervisory device, for controlling opening/closing of the opening/closing member in accordance with the identification information input to the input section and for controlling the display section to display elevator information of the plurality of elevators, in which the display section is provided on a side surface of the gate box body on the passage side and includes a display screen provided so as to be inclined with respect to a direction of passage of the user so as to be oriented to an entrance side of the security gate.

### ADVANTAGEOUS EFFECTS OF INVENTION

The elevator system according to the present invention includes the display section which is provided on the side surface of the gate box body on the passage side so as to be inclined. Therefore, the possibility of overseeing the elevator information is reduced when the elevator information is viewed from the user who is going to pass through the security gate. As a result, an efficient travel of the plurality of elevators is enabled.

### BRIEF DESCRIPTION OF DRAWINGS

FIG. 1 is a configuration diagram illustrating an elevator system according to Embodiment 1 of the present invention, which is illustrated partially in blocks.

FIG. 2 is a perspective view illustrating a first gate box body illustrated in FIG. 1.

FIG. 3 is a plan view illustrating a security gate illustrated in FIG. 1.

FIG. 4 is a front view illustrating the security gate illustrated in FIG. 1.

FIG. 5 is a right side view illustrating the security gate illustrated in FIG. 4.

FIG. 6 is a flowchart illustrating an operation of a gate control section, which is performed when an ID card is brought closer to a card reader illustrated in FIG. 1.

FIG. 7 is a plan view illustrating a principal part of a security gate according to Embodiment 2 of the present invention.

### DESCRIPTION OF EMBODIMENTS

Hereinafter, embodiments of the present invention are described referring to the drawings.

### Embodiment 1

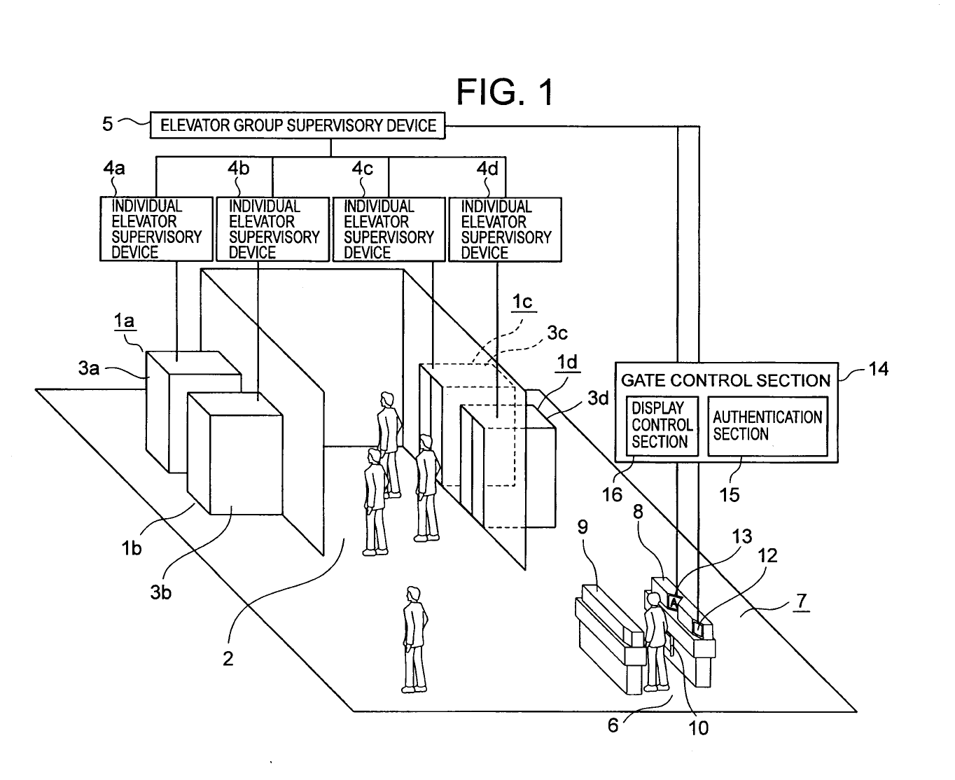

FIG. 1 is a configuration diagram illustrating an elevator system according to Embodiment 1 of the present invention, which is illustrated partially in blocks. In the figure, first to fourth elevators 1a to 1d are available at a common elevator landing 2. The first elevator la (elevator A) includes a first car 3a and a first individual elevator supervisory device 4a for controlling raising and lowering of the first car 3a. The second elevator 1b (elevator B) includes a second car 3b and a second individual elevator supervisory device 4b for controlling raising and lowering of the second car 3b. The third elevator 1c (elevator C) includes a third car 3c and a third individual elevator supervisory device 4c for controlling raising and lowering of the third car 3c. The fourth elevator 1d (elevator D) includes a fourth car 3d and a fourth individual elevator supervisory device 4d for controlling raising and lowering of the fourth car 3d.

The individual elevator supervisory devices 4a to 4d are controlled by an elevator group supervisory device 5. Specifically, a travel of the elevators 1a to 1d is supervised by the elevator group supervisory device 5 as a group.

A security gate 7 for allowing and inhibiting the entry of a user to the elevator landing 2 is provided to a passage 6 to the elevator landing 2. The security gate 7 includes a first gate box body 8, a second gate box body 9, a first opening/closing member 10, a second opening/closing member 11 (FIG. 3), a card reader 12 corresponding to an input section, a display section 13, and a gate control section 14.

The first gate box body 8 and the second gate box body 9 are stood on both sides of the passage 6. The first opening/closing member (flapper) 10 and the second opening/closing member (flapper) 11 are respectively provided to the gate box bodies 8 and 9 so as to be each tunable about a vertical axis to open/close the passage 6.

The card reader 12 and the display section 13 are provided to the first gate box body 8. Identification information stored in an ID card (non-contact card) carried by the user is input from the card reader 12. As the display section 13, for example, a liquid crystal display, an LED display device, or the like is used.

The gate control section 14 is provided inside the first gate box body 8. The gate control section 14 is connected to the elevator group supervisory device 5. Further, the gate control section 14 includes an authentication section 15 and a display control section 16.

The authentication section 15 performs personal authentication in accordance with the identification information input to the card reader 12 to control opening/closing of the opening/closing members 10 and 11 based on the result of authentication. The gate control section 14 transmits destination floor information contained in the identification information to the elevator group supervisory device 5. The elevator group supervisory device 5 selects and assigns any of the elevators 1a to 1e in accordance with the destination floor information from the gate control section and transmits the elevator information of the assigned one of the elevators la to ld to the gate control section 14. The display section 16 displays the elevator information on the display section 13.

Each of the individual elevator supervisory devices 4a to 4d, the elevator group supervisory device 5, and the gate control section 14 each include a microcomputer. The functions of the gate control section 14 are realized by the microcomputer.

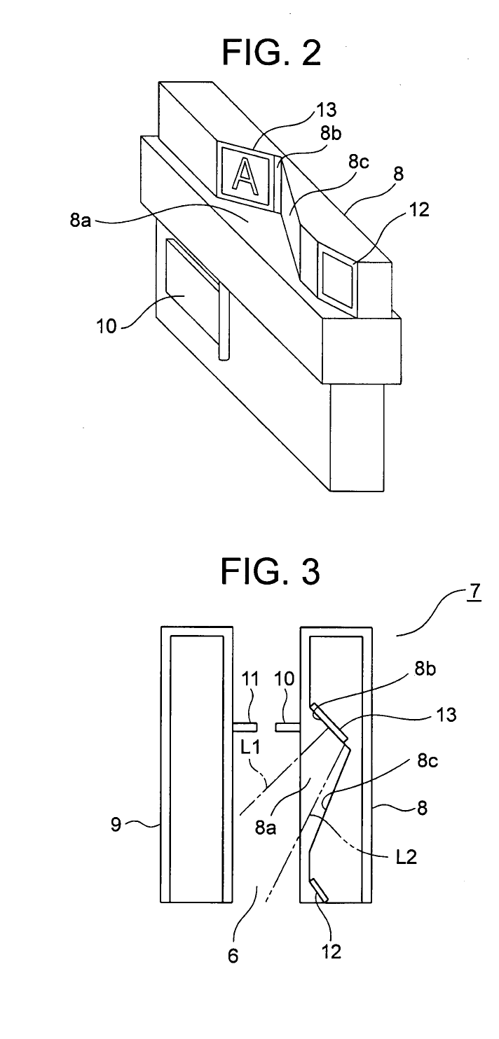

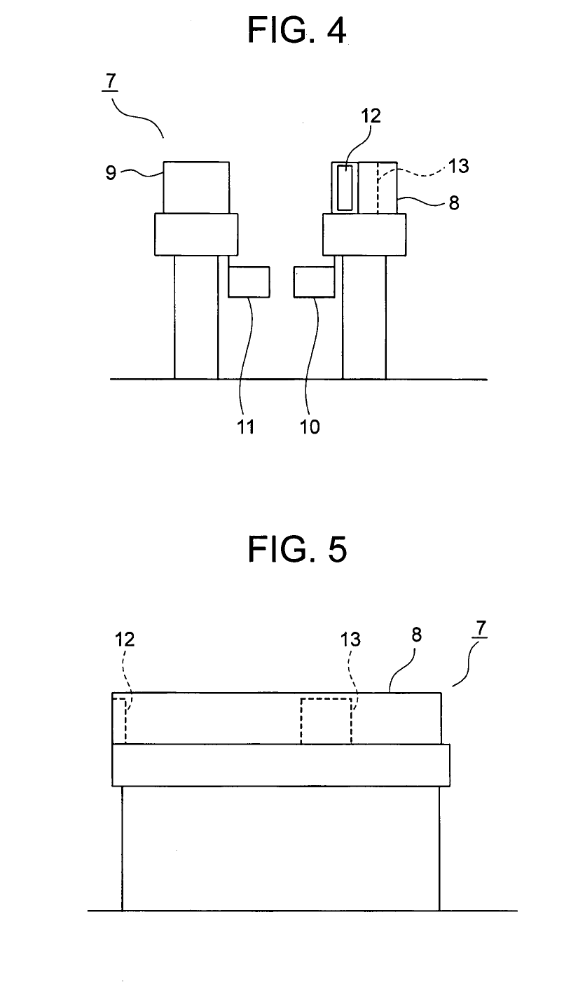

FIG. 2 is a perspective view illustrating the first gate box body 8 illustrated in FIG. 1, FIG. 3 is a plan view illustrating the security gate 7 illustrated in FIG. 1, FIG. 4 is a front view illustrating the security gate 7 illustrated in FIG. 1, and FIG. 5 is a right side view illustrating the security gate 7 illustrated in FIG. 4. The card reader 12 and the display section 13 are provided on a side surface of the first gate box body 8 on the passage 6 side. Moreover, the card reader 12 is provided to an end portion of the security gate 7 on the entrance side.

Further, a surface (input surface) of the card reader 12 is vertical to a surface on which the security gate 7 is installed (floor surface) and is inclined with respect to a direction of passage of the user(s) so as to be oriented to the entrance side of the security gate 7.

The display section 13 is provided to a middle portion of the first gate box body 8 and approximately at the same position as that of the first opening/closing member 10 in the direction of passage of the user(s). Specifically, the display section 13 is provided approximately immediately above the first opening/closing member 10. The display section 13 is provided at the same height as that of the card reader 12. Further, a display screen of the display section 13 is vertical to the surface on which the security gate 7 is installed (floor surface) and is inclined with respect to the direction of passage of the user(s) so as to be oriented to the entrance side of the security gate 7.

On the side surface of the first gate box body 8 on the passage 6 side, a concave portion 8a having a triangular shape as viewed immediately above is provided. The display section 13 is provided so as to externally face the concave portion 8a. The concave portion 8a includes a first wall surface 8b located on the downstream side of the passage 6 and a second wall surface 8c located on the upstream side of the passage 6. The display section 13 is embedded in the first wall surface 8b so that the display screen is exposed to the concave portion 8a. The second wall surface 8c forms an obtuse angle with respect to the first wall surface 8b.

Moreover, as illustrated in FIG. 3, when the security gate 7 is viewed from immediately above, a straight line (alternate long and short dash line L1) extending from the center of the display screen of the display section 13 vertically to the display screen crosses an area of the passage 6, which is located at the upstream of the opening/closing members 10 and 11.

Further, when the security gate 7 is viewed from immediately above, the second wall surface 8c is located on the outer side of a straight line (alternate long and two short dashes line L2) connecting one end portion of the display section 13 in a width direction (end portion on the second wall surface 8c side) and the center of the entrance of the security gate 7.

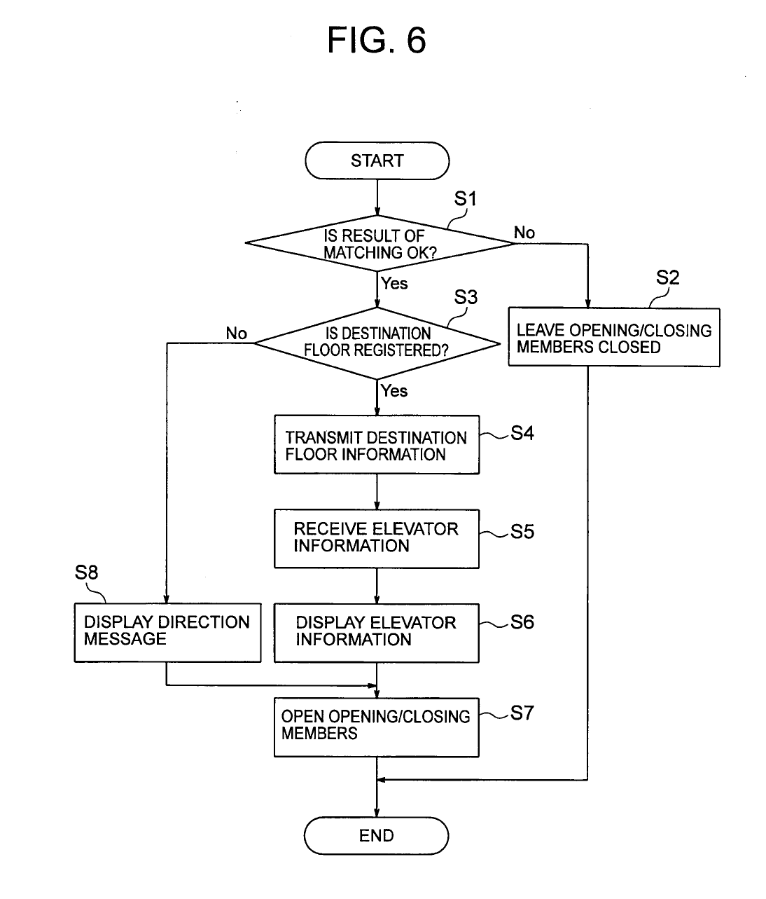

FIG. 6 is a flowchart illustrating an operation of the gate control section 14, which is performed when the ID card is brought closer to the card reader 12 illustrated in FIG. 1. When the user brings the ID card closer to the card reader 12, the authentication section 15 acquires the identification information registered on the ID card and compares the identification information to pre-registered data so as to verify whether or not the user carrying the ID card is allowed to pass therethrough. Specifically, it is verified whether or not the result of matching of the identification information is OK (Step S1). Then, when the result of matching is NO, the opening/closing members 10 and 11 are left closed (Step S2).

When the result of matching is OK, the gate control section 14 then verifies whether or not a valid destination floor (for example, a floor on which the user resides, an office floor for the user, or the like) is registered on the ID card (Step S3). When the effective destination floor is registered, the gate control section 14 transmits the destination floor information to the elevator group supervisory device 5 (Step S4).

As a result, the elevator group supervisory device 5 determines the elevator to be assigned to the user traveling from a floor on which the security gate 7 is installed to the destination floor contained in the determination floor information to dispatch the assigned elevator to a landing floor, and transmits the information of the elevator name of the assigned elevator as elevator information to the gate control section 14.

When receiving the elevator information from the elevator group supervisory device 5 (Step S5), the display control section 16 controls the display section 13 to display the elevator information (Step S6) and opens the opening/closing members 10 and 11 (Step S7). Thereafter, when the passage of the user through the security gate 7 is detected by a passage sensor (not shown), the gate control section 14 closes the opening/closing members 10 and 11. Further, when the boarding of the user on the car 3a, 3b, 3c, or 3d of the allocated elevator is detected, a destination floor button in the car 3a, 3b, 3c, or 3d is automatically registered.

On the other hand, when the valid destination floor is not registered on the ID card, the display control section 16 controls the display section 13 to display a direction message (for example, “press the destination floor button at the landing” or the like) for prompting the registration of the destination floor on a landing operating panel (not shown) provided to the elevator landing 2 (Step S8), and opens the opening/closing members 10 and 11 (Step S7). Thereafter, when the passage of the user through the security gate 7 is detected by the passage sensor, the gate control section 14 closes the opening/closing members 10 and 11.

When the user presses the destination floor button on the landing operating panel, the elevator group supervisory device 5 determines the elevator to be assigned so as to dispatch the assigned elevator to the landing floor and controls a display section of the landing operating panel to display the information of the elevator name of the assigned elevator. Thereafter, when the boarding of the user on the car 3a, 3b, 3c, or 3d of the assigned elevator is detected, the destination floor button in the car 3a, 3b, 3c, or 3d is automatically registered.

In the elevator system described above, the display section 13 is provided on the side surface of the gate box body 8, which faces the passage 6, so as to be inclined. Therefore, the display section 13 can be provided at the position close to the opening/closing members 10 and 11 as viewed from the user who is going to pass through the security gate 7. As a result, the possibility of overlooking the elevator information can be reduced to enable the efficient travel of the elevators 1a to 1d.

Further, even when the height of the gate box body 8 is relatively large, the display section 13 can be easily visually recognized as compared to the case where the display section 13 is provided on the upper surface of the gate box body 8.

Further, even when a width size of the gate box body 8 is small, a large display screen can be ensured to provide ease of visual recognition of the display section 13 as compared to the case where the display section 13 is provided on the upper surface of the gate box body 8.

For an automatic ticket gate provided at a station, or the like, a user is not necessarily required to verify the display information. In the elevator system according to Embodiment 1, however, the elevators 1a to 1d are not allowed to efficiently travel if the user does not verify the elevator information. Therefore, it is extremely important to more reliably prompt verification of the elevator information at the passage through the security gate 7.

In this regard, in the elevator system according to Embodiment 1, even if the opening/closing members 10 and 11 are opened immediately after the display of the elevator information, the user can verify a state of the opening/closing members 10 and 11 and the elevator information in approximately the same direction while passing through the passage 6. Therefore, the user can smoothly pass through the security gate 7. As a result, a processing time for one user can be reduced, while the number of processed users per unit time can be increased.

For example, the opening/closing members 10 and 11 may be opened a little while after the display of the elevator information. As a result, a time allowing the user to verify the elevator information on the display section 13 can be slightly increased. Thus, the elevator information can be further prevented from being overlooked when the user passes between the opening/closing members 10 and 11.

Further, the concave portion 8a is provided on the side surface of the gate box body 8, and the display section 13 is provided so as to externally face the concave portion 8a. Therefore, even though the display section 13 is provided so as to be inclined, the display section 13 does not protrude into the passage 6. Thus, the passage is not hindered. Moreover, the visual recognition of the display section 13 from the vicinity of the entrance of the security gate 7 can be ensured. Further, the display section 13 can be retained with sufficient strength.

### Embodiment 2

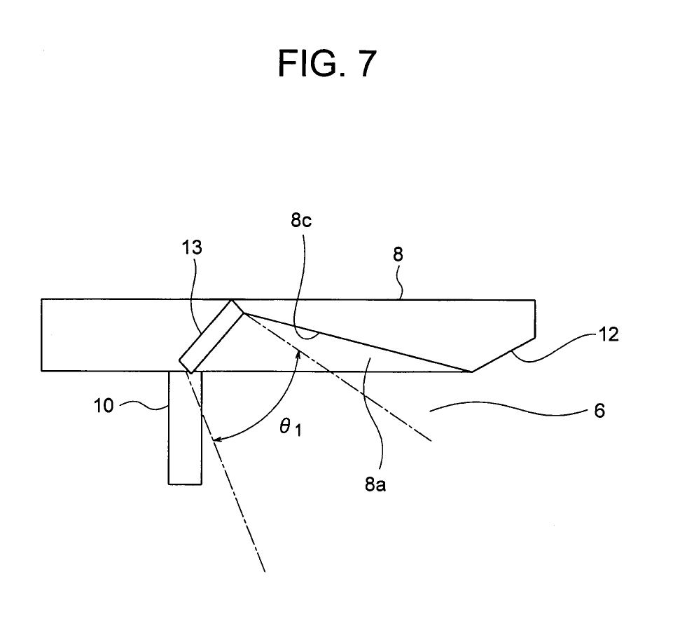

Next, FIG. 7 is a plan view illustrating a principal part of a security gate according to Embodiment 2 of the present invention. In the figure, the card reader 12 is provided to an entrance portion of the security gate (side end portion of the gate box body 8 at the upstream). The display section 13 has a specific viewing angle θ1 and is provided in the vicinity of the opening/closing member (flapper) 10. A concave portion (notch portion) 8a is formed by notching the gate box body 8 from an inner side end portion of the entrance portion of the security gate to the back of the display section 13.

A first end portion of the display section 13 in the width direction is provided in the vicinity of the opening/closing member 10. A second end portion of the display section 13 in the width direction is provided so as to be in contact with the outer side of the gate box body 8. Further, a walking introduction area (area of the passage 6, which is located on the upstream side of the opening/closing member 10), and the viewing angle θ overlap each other. In other words, when the security gate is viewed from immediately above as illustrated in FIG. 7, the range in which the display on the display section 13 is normally viewed (area indicated by the angle θ1 of FIG. 7) overlaps the walking introduction area. The remaining configuration is the same as that of Embodiment 1.

According to the security gate described above, the one end portion of the display section 13 is provided in the vicinity of the opening/closing member 10, whereas the other end portion of the display section 13 is provided so as to be in contact with the outer side of the security date. The walking introduction area and the range of the viewing angle θ1 overlap each other. Therefore, the possibility of overlooking the display information on the display section 13 can be reduced.

Even for the security gate 7 according to Embodiment 1, one end portion of the display section 13 is provided in the vicinity of the opening/closing member 10, whereas the other end portion of the display section 13 is provided in the outer side portion of the security gate. The region within the range of the viewing angle of the display section 13 overlaps the walking introduction area. Therefore, even according to the security gate 7 of Embodiment 1, the same effects as those of Embodiment 2 can be obtained.

The input section is not limited to the card reader 12, and may be, for example, a device for reading the identification information recorded on an object (for example, a cellular phone) other than a card, an input device for a personal identification number, a biometric authentication device, or the like.

Further, the opening/closing members 10 and 11 are not limited to those of type to be turned about a vertical axis, and may be, for example, slide doors or the like.

Further, the gate control section 14 may be provided outside of the gate box body 8 and can be provided in the vicinity of the elevator group supervisory device 5 or provided in the elevator group supervisory device 5.

Further, the functions of the gate control section 14 may be distributed to a plurality of devices to be executed.

Further, the display section 13 may be provided on the downstream side or the upstream side of the opening/closing members 10 and 11 in the direction of passage of the user(s).

Further, the display section 13 may be provided to the second gate box body 9 or may be provided to each of the first gate box body 8 and the second gate box body 9.

Moreover, in Embodiments 1 and 2, the display section 13 may be provided turnably about the vertical axis so that an angle of the display section 13 is adjustable.

Further, in Embodiments 1 and 2, the display section 13 may be provided turnably about a horizontal axis so that an elevation/depression angle of the display section 13 is adjustable.

Further, a plan shape of the concave portion 8a is not limited to the triangle, and may be, for example, a shape obtained by connecting the first wall surface 8b and the second wall surface 8c with a curved surface, a trapezoid, or the like.

1. An elevator system, comprising:
a plurality of elevators available at a common elevator landing;
an elevator group supervisory device for controlling travel of the plurality of elevators; and
a security gate including: a gate box body arranged vertically on a side of a passage to the common elevator landing; an opening/closing member provided to the gate box body, for opening/closing the passage; an input section provided to the gate box body, for inputting identification information of a user; a display section provided to the gate box body; and a gate control section connected to the elevator group supervisory device, for controlling opening/closing of the opening/closing member in accordance with the identification information input to the input section and for controlling the display section to display elevator information of the plurality of elevators,
wherein the display section is provided on a side surface of the gate box body on the passage side and includes a display screen provided so as to be inclined with respect to a direction of passage of the user so as to be oriented to an entrance side of the security gate.

2. The elevator system according to claim 1, wherein:
a concave portion is provided on the side surface of the gate box body on the passage side; and
the display section is provided so that the display screen externally faces the concave portion.

3. The elevator system according to claim 1, wherein the gate control section first controls the display section to display the elevator information and then opens the opening/closing member.

4. The elevator system according to claim 1, wherein:
the display section has a specific viewing angle;
a first end portion of the display section is provided in a vicinity of the opening/closing member;
a second end portion of the display section is provided in an outer side portion of the gate box body; and
a walking introduction area of the passage in the security gate, which is located at upstream of the opening/closing member, and an area within a range of the viewing angle overlap each other.
